(19) United States
(12) Patent Application Publication
(10) Pub. No.: US 2025/0371753 A1
(43) Pub. Date: Dec. 4, 2025

(54) CONTENT AWARE BACKGROUND GENERATION

(71) Applicant: Adobe Inc., San Jose, CA (US)

(72) Inventors: Rishav Agarwal, Panathur (IN); Sanyam Jain, New Delhi (IN); Harshit Bhatt, Ranikhet (IN); Jnaneswara Rao Rompilli, Vizianagaram (IN); Garvit Sethi, Bhilwara (IN); Shreya Singhal, Roorkee (IN)

(73) Assignee: Adobe Inc., San Jose, CA (US)

(21) Appl. No.: 18/680,351

(22) Filed: May 31, 2024

(51) Int. Cl. G06T 11/00; G06T 13/00

(52) U.S. Cl. CPC G06T 11/001; G06T 13/00; G06T 2211/441

(57) ABSTRACT

Content aware background generation techniques are described. In one or more examples, a background generation system forms a mask from a digital image and receives an input specifying one or more parameters. The background generation system then generates a background using a machine-learning model and generative artificial intelligence by predicting pixel values based on the digital image, the one or more parameters, and the mask using a loss function. The background is then applied to the digital image and presented for display in a user interface.

### BACKGROUND

Designers often face a daunting task of manually searching for a background to complement foreground objects in a digital image as part of creating an overall digital content design. This process, in real-world scenarios, is often time-consuming, frustrating and error prone.

The designer, for instance, is tasked with scouring online sources for suitable background images. Once located, multiple iterations may be undertaken manually using photo editing tools to adjust a layout context to harmonize the background with foreground objects of a digital image. For example, designers are often confronted with scenarios that involve altering a background to not interfere with foreground objects, often resorting to use of opaque text boxes placed behind text to maintain visibility (e.g., readability) of the objects in a way that often visually interferes with the overall design.

### SUMMARY

Content aware background generation techniques are described. In one or more examples, a background generation system generates a background based on a digital image as aware of objects included in the digital image that define a foreground. The background generation system uses a mask to identify the foreground and background regions. The background generation system also supports user control of parameters to guide a background generation process of a machine-learning model using generative artificial intelligence.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ content aware background generation techniques described herein.

FIG. 2 depicts a system in an example implementation showing operation of a background generation system of FIG. 1 in greater detail as generating a background based on a digital image.

FIG. 3 depicts a system in an example implementation showing operation of a mask generation system of FIG. 2 in greater detail.

FIG. 4 depicts a system in an example implementation showing operation of a control module of FIG. 2 in greater detail as outputting controls to specify parameters usable to guide operation of the machine-learning model in generating a background.

FIG. 5 depicts a system showing training of a machine-learning model of FIG. 2 in greater detail.

FIG. 6 depicts an example implementation showing an architecture of a machine-learning model of FIG. 5.

FIG. 7 depicts an example implementation showing different amounts of variance as applied by a machine-learning model of the background generation system as part of background generation.

FIG. 8 depicts an example implementation showing dynamic background capabilities as applied by a machine-learning model of the background generation system as part of background generation.

FIG. 9 depicts an example implementation showing pattern background capabilities as applied by a machine-learning model of a background generation system as part of background generation.

FIG. 10 is a flow diagram depicting an algorithm as a step-by-step procedure in an example implementation of operations performable for accomplishing a result of content aware background generation based on a digital image.

FIG. 11 illustrates an example system including various components of an example device that can be implemented as any type of computing device as described and/or utilize with reference to the previous figures to implement embodiments of the techniques described herein.

### DETAILED DESCRIPTION

### Overview

Backgrounds as part of digital images are a primary element in an overall visual appeal of the digital images. Backgrounds are usable to enhance a visual depth of a digital image, captivate a reader's interest, establish a desired mood or feeling, and so on. However, conventional usage scenarios are generally limited to use of pre-existing images or use of basic image editing tools to achieve simplistic results with limited flexibility and without an ability to support coordination with objects (e.g., text or graphics) included in a foreground of the digital image.

Designers, for instance, are often confronted with a manual process to locate backgrounds suitable for use with objects in a foreground of a digital image that can be both time-consuming, frustrating, and error prone. Once located, the designers are then tasked with refining the backgrounds manually to fit a layout of the objects, ensure that the background does not interfere with visibility of the objects, and so forth. Although automated techniques have been developed, conventional automated techniques are hindered in real-world scenarios by mediocre performance, slow image generation, lack of color support (e.g., two or fewer colors), and a lack of user control.

Accordingly, content aware background generation techniques are described in which a machine-learning model is employed to generate a background for a digital image, automatically and without user intervention, using generative artificial intelligence (AI). The techniques are usable to generate multicolored abstract backgrounds (e.g., having three or more colors) and support user controls to control operation of the machine-learning model, e.g., to control an amount of variance, honor a color theme exhibited by the digital image, specify one or more seed primary colors to be used in the background, and so forth. In this way, the content aware background generation techniques support increased richness and user control that is not possible in conventional techniques, thereby improving computational resource efficiency and accuracy in generating the background.

In one or more examples, a background generation system receives a digital image, for which, a background is to be generated. A mask is then formed by the background generation system based on one or more objects disposed in a foreground of the digital image. The mask, for instance, is configurable to include pixels having a first color (e.g., white) to indicate objects in a foreground and pixels in a second color (e.g., black) to indicate a background.

The background generation system is also configurable to support inputs to guide background generation. A user interface, for instance, may be output having controls that are usable to set parameters to control how the background is generated by a machine-learning model. The control, for example, may be configured as a slider that is user selectable to set variance as a relative amount of randomization employable by the machine-learning model in generating the background. In another example, the control is usable to specify one or more seed primary colors (e.g., using a color wheel) that are to be used in the background. In a further example, the control is configured to control color generation such that the machine-learning model is constrained to honor a color theme of the digital image, e.g., objects in a foreground. A variety of other examples are also contemplated.

The machine-learning model then generates the background based on the mask, the digital image, and the parameters when available. The machine-learning model, for instance, is configurable as a compositional pattern producing neural network (CPPN) that utilizes a function that defines an intensity of the digital image at respective points in space. The functional may be implemented mathematically, represented by a neural network with weights connecting activations gates, and so forth.

In an implementation, additional parameters are added. A first such parameter is a latent vector of “n” dimensions that is usable in support of generating the background as an animation. A second such parameter is a radial distance from a fixed point that is usable to achieve radial and symmetric effects as part of the background.

The machine-learning model generates the background using artificial intelligence by employing a loss function. The loss function is configurable to support a variety of loss terms in order to guide the generation of the background. A first loss term, for instance, is a background opaque loss term configured to control opacity of background regions. A second loss term is a foreground transparent loss term configured to control transparency of foreground regions. A third loss term is an input color theme term configured to cause colors of the predicted values to correspond to a particular color theme, e.g., a primary seed color, color of the digital image, and so forth.

Using the loss function, the machine-learning model generates values for pixels of the background. The values, for instance, are defined using hue, saturation, brightness, and alpha (HSBA), red, green, and blue (RGB), and so forth. The background is then combined by the background generation module with the digital image (e.g., based on the mask), which is presented for display in a user interface. In an implementation, the background generation module is configured to automatically adjust the background to respond to changes in the foreground, and as such is dynamically responsive to objects in the foreground which is not possible in conventional techniques.

In this way, the background generation system addresses technical challenges of conventional techniques in support of improved operation, reduction in computational resource consumption, increased visual richness (e.g., in both color and variation), and user control. Further discussion of these and other examples is included in the following sections and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Compositional Pattern Producing Neural Networks (CPPNs) are a specialized type of artificial neural network designed to generate complex patterns and structures. Unlike conventional neural networks, which typically output numerical predictions or binary classifications, CPPNs are usable to generate patterns in the field of generative art. CPPNs have an architecture that evolves through genetic algorithms, which allows CPPNs to develop and refine pattern-producing capabilities over time. CPPNs are configurable using a diverse set of activation functions, such as sigmoid, Gaussian, and periodic functions like sine. This variety allows CPPNs to create a wide range of patterns, including segmented, symmetric, and fractal-like structures. Additionally, CPPNs are configurable to encode digital images at an infinite resolution and as such are sampleable at any desired resolution for optimal display.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Content Aware Background Generation Environment

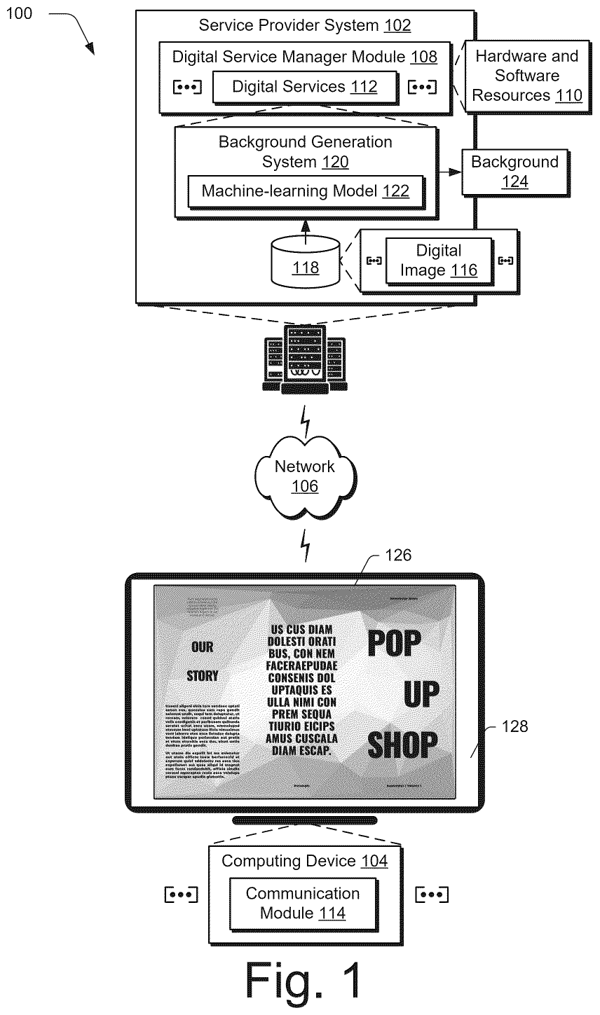

FIG. 1 is an illustration of a digital medium environment 100 in an example implementation that is operable to employ content aware background generation techniques described herein. The illustrated environment 100 includes a service provider system 102 and a computing device 104 that are communicatively coupled, one to another, via a network 106. Computing devices are configurable in a variety of ways.

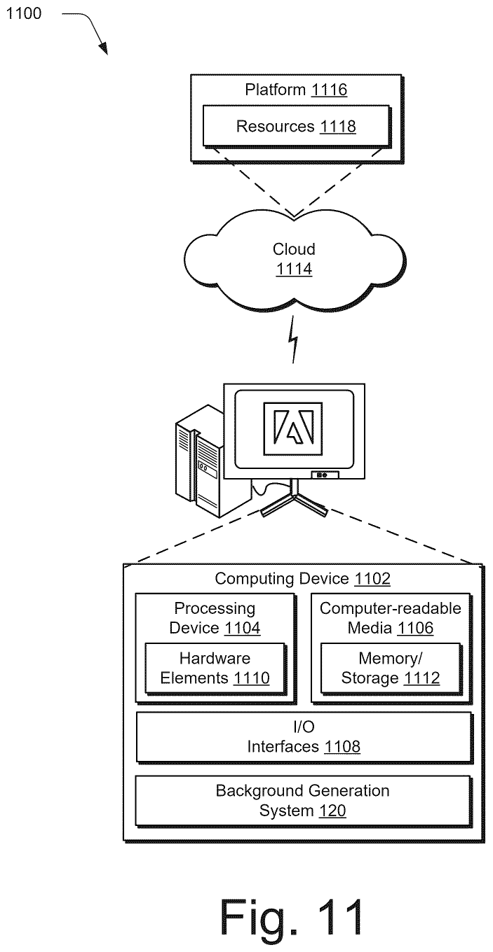

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 11.

The service provider system 102 includes a digital service manager module 108 that is implemented using hardware and software resources 110 (e.g., a processing device and computer-readable storage medium) in support of one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

A digital image 116 is illustrated as stored in a storage device 118 accessible by the service provider system 102, e.g., locally at the service provider system 102, remotely via the network 106, and so forth. The digital image 116 is configurable in a variety of ways, such as a bitmap, JPEG, PNG, digital template, digital document, spreadsheet, digital presentation, and so forth.

In the illustrated example, the digital services 112 are utilized to implement a background generation system 120 that employs a machine-learning model 122 to generate a background 124 for inclusion as part of a digital image 116. As previously described, a background plays a significant role in the digital image design, significantly contributing to an overall visual appeal. A carefully selected background, for instance, is usable to add depth to a document, capture a reader's attention, and set a desired tone or feelings. However, conventional techniques limit creative flexibility by being restricted to use of pre-existing digital images and basic image editing tools to create simplistic backgrounds.

To address these technical challenges, the background generation system 120 supports a range of options for creating a captivating and visually rich background 124, which is not possible in conventional techniques. The background generation system 120, for instance, is configurable to empower designers with a degree of user control that is not possible in conventional techniques to expand creativity and achieve desired visual outcomes, effectively elevating a quality and appeal of the digital image 116 and corresponding background 124.

In conventional techniques, for instance, contrasting opaque shapes are often used behind text to ensure legibility. However, these conventional techniques are not visually pleasing, lack creativity, and generally appear outdated in practice. Although generative artificial intelligence models have been developed, conventional techniques to do so do not support abstract digital images. Additionally, conventional generative artificial intelligence techniques are not content or layout aware and thus may interfere with objects included in the digital image, do not support user control, and are computationally costly to implement.

However, in the techniques described herein the background generation system 120 is configured to take into account a layout of objects in a foreground, such as graphics and text. Therefore, the background generation system 120 is configurable to generate the background 124 to complement and enhance the readability of the text and other objects, resulting in a visually appealing and cohesive design.

The background generation system 120, for instance, is configurable to generate the background 124 as a multicolored abstract digital image, e.g., having three or more colors which is not possible in conventional techniques. The abstract digital image, for instance, is utilized to portray ideas or concepts using visualizations that do not have an immediate association with the physical world, an example 126 of which is shown in a user interface 128 presented by the computing device 104 in FIG. 1.

To do so, the background generation system 120 supports use of controls to control generation of the background 124 by the machine-learning model 122, such as color controls, honor foreground, variance, and more. The background generation system 120 is also configured to support generation of a diverse range of backgrounds, including animations (e.g., dynamic backgrounds), radial backgrounds, symmetric backgrounds, metallic backgrounds, patterns (e.g., triangular, rectangular, waves), and so forth. By moving away from conventional techniques to instead address a concept of objects in a foreground of the digital image 116, the background generation system 120 is configured to generate the background 124 with increased visual harmony and visual engagement, elevating an overall quality and impact of the digital image 116 that is not possible in conventional techniques.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Background Generation

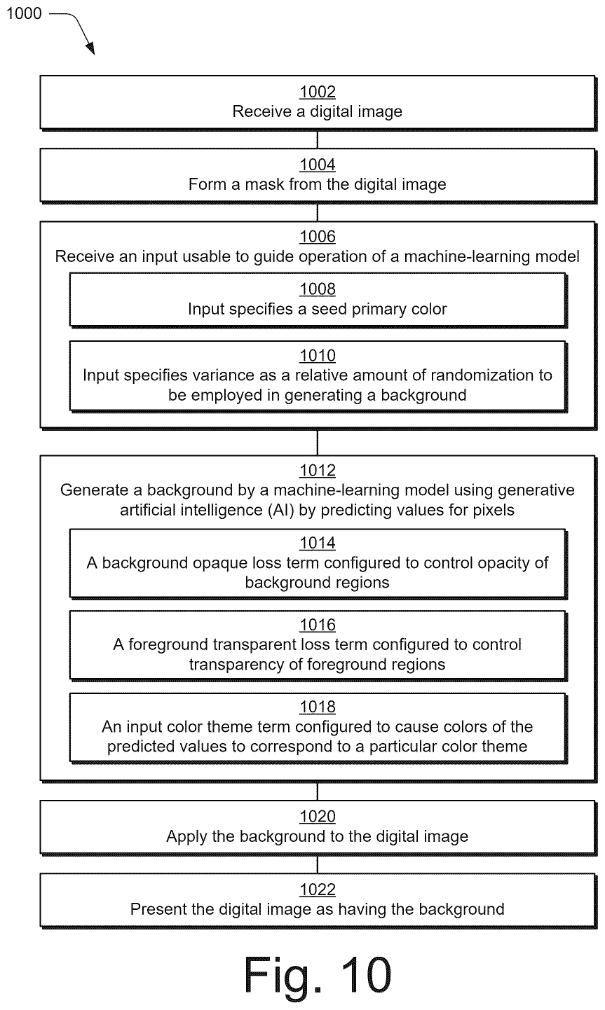

The following discussion describes content aware background generation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 10 is a flow diagram depicting an algorithm 1000 as a step-by-step procedure in an example implementation of operations performable for accomplishing a result of content aware background generation based on a digital image. In portions of the following discussion, reference will be made in parallel to FIG. 10.

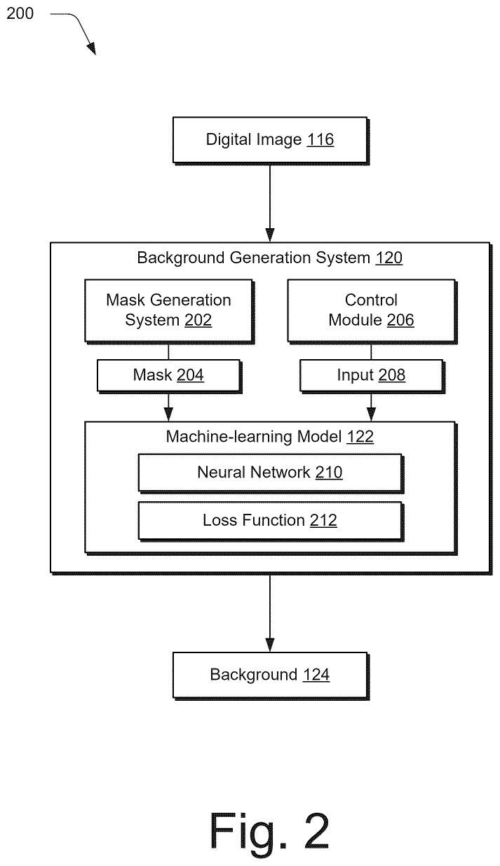

FIG. 2 depicts a system 200 in an example implementation showing operation of the background generation system 120 of FIG. 1 in greater detail as generating a background 124 based on a digital image 116. To begin in the illustrated example, a digital image 116 is received (block 1002) by the background generation system 120, e.g., a JPEG image, PNG image, bitmap, and so forth. The digital image 116, for instance, is provided via user interaction with a user interface to select the digital image 116 from a storage device 118.

A mask generation system 202 is then utilized to form a mask 204 from the digital image 116 (block 1004). The mask 204, for instance, is configurable to include pixels having a first color (e.g., white) to indicate objects in a foreground and pixels in a second color (e.g., black) to indicate a background of the digital image 116.

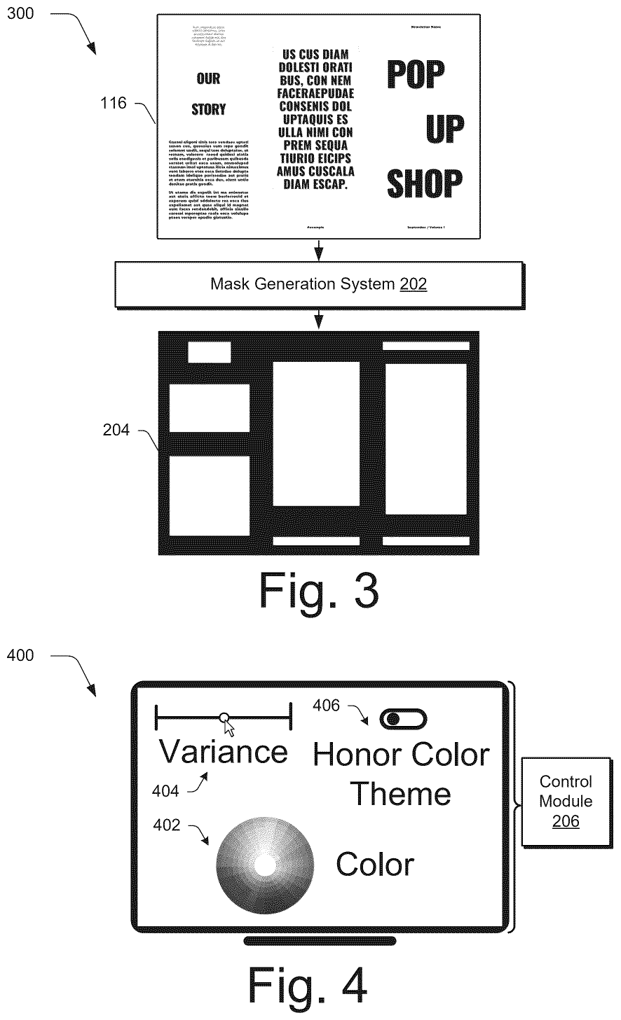

FIG. 3 depicts a system 300 in an example implementation showing operation of the mask generation system 202 of FIG. 2 in greater detail. To generate the mask imae, the mask generation system 202 starts by duplicating the digital image 116 as a hidden artboard, e.g., in a separate document. To do so in the illustrated example, the mask generation system 202 creates a rectangular object having the same dimensions as the artboard, positioning the rectangle at a lowest z-index in a visual layer of the digital image 116, and coloring the object black to create the background. Content of the objects on the artboard, such as text or graphics, is removed thereby leaving a wireframe. These objects are then outlined and filled with white color to denote objects in the foreground.

The artboard, which contains the black background and white objects, is exported as a greyscale image to generate the mask 204. To provide the machine-learning model 122 with additional information, locations of objects (e.g., graphics and text frames) within the digital image 116 are indicated to further control how the background 124 is generated around graphics as opposed to text. The resulting mask 204 contains white pixels corresponding to the foreground objects and black pixels representing the background.

Returning again to FIG. 2, a control module 206 of the background generation system 120 receives an input 208 to guide operation of the machine-learning model 122 (block 1006). The control module 206, for instance, is configured to present a control for display in a user interface to enable user control of “how” the background 124 is generated and “what” is generated in the background 124, which is not possible in conventional techniques.

FIG. 4 depicts a system 400 in an example implementation showing operation of the control module 206 of FIG. 2 in greater detail as outputting controls to specify parameters usable to guide operation of the machine-learning model 122 in generating the background 124. In a first example, an input is received via a color control 402 that specifies a seed primary color (block 1008) as a single color, a color palette, and so on. In the illustrated example, the color is selected through interaction with a color wheel, although other examples are also contemplated such as to base the selection on colors from the digital image 116 as further described below.

Hue, saturation, and brightness (HSB) are color properties that can be used to represent colors in an image. Hue refers to the actual color of the pixel, such as red, blue, or green. Saturation refers to how pure or intense the color is, while brightness refers to how light or dark the color is. These three values can be used to represent colors in a way that is more intuitive for humans to understand and work with than the traditional RGB color space.

In image processing and computer vision, the HSB color model may be used as a pre-processing step for feature extraction and object detection tasks. For example, the hue value can be used to separate different colored objects in an image, while the saturation value can be used to determine how well a color stands out against its surroundings. Accordingly, in one or more implementations hue and saturation values are used to adjust the color of the digital image 116, i.e., the foreground image. This helps to increase the diversity of training data usable to train the machine-learning model 122 as further described later in the following discussion and increases robustness of the machine-learning model 122 to variations in color. The brightness value is also adjusted to simulate different lighting conditions. Use of HSB color space supports increased user control and choices in color selection.

In a second example, a variance control 404 implemented as a slider is configured to provide an input that specifies variance as a parameter to indicate a relative amount of randomization to be employed by the machine-learning model 122 in generating a background 124 (block 1010). In this example, a higher variance value results in increased variance and therefore increased differences in backgrounds 124 generated by the machine-learning model 122, while a lower variance value results in smoother looking images. Thus, this parameter can be used to fine-tune the amount of variation in the background 124 by a user for particular use cases, which is not possible in conventional techniques.

In a third example, an honor foreground theme control 406 is provided as a slider to specify a parameter indicating that the machine-learning model 122 is to employ increased aggressiveness in preserving colors included the digital image 116, e.g., objects included in the foreground of the digital image 116. A variety of other examples are also contemplated.

Returning again to FIG. 2, a background 124 is generated by the machine-learning model 122 using generative artificial intelligence (AI) by predicting values for pixels based on the digital image 116 (block 1012) and inputs 208, if any, specifying parameters as described above. To do so, the machine-learning model 122 employs a neural network 210 and a loss function 212. The neural network 210 is configurable in a variety of ways, an example of which includes a compositional pattern producing neural network (CPPN).

A CPPN function, represented as “c=f (x, y),” defines an intensity at each point in space, thereby suitable for generating high-resolution digital images. This function can be built using various mathematical operations or represented by a neural network 210 with weights “(w)” connecting activation gates that remain constant when generating an image as the background 124, thus defining the entire image as “f (w, x, y).” Additionally, two additional parameters “Z” and “r” are added in this example. “Z” is a latent vector of “n” dimension which is usable to support a variety of functionalities such as live backgrounds and animations. The parameter “r” is a radial distance from a fixed point, e.g., a center or other configurable value. The parameter “r” supports additional functionalities such as radial and symmetric effects in generating the background 124. Hence the background 124 is definable by a function “f(w, z, x, y, r).”

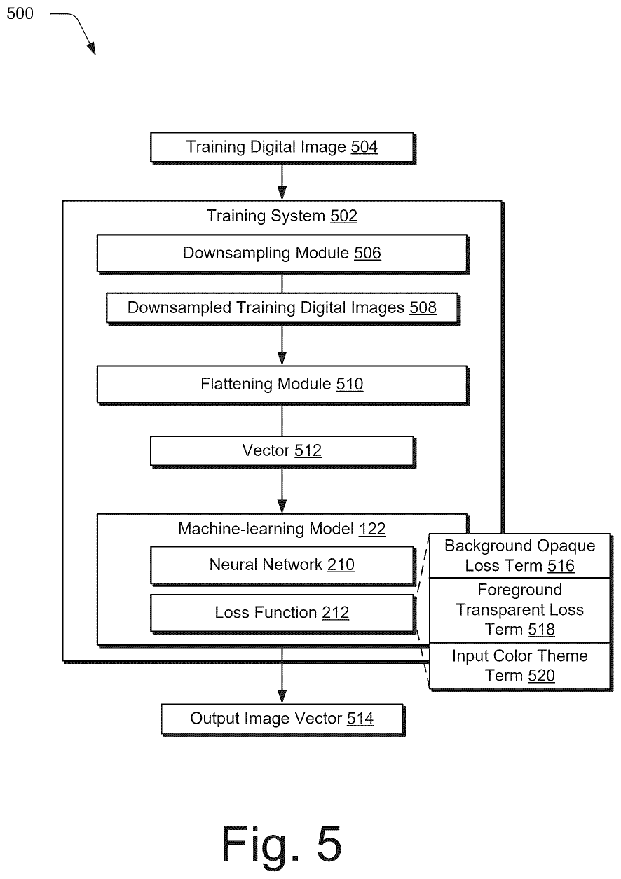

FIG. 5 depicts a system 500 showing training of the machine-learning model 122 of FIG. 2 in greater detail. The machine-learning model 122 is configured in this example to generate the background 124 as a HSBA (Hue, Saturation, Brightness, Alpha) image using a neural network 210. The neural network 210 is trained using a loss function 212 that penalizes discrepancies between a predicted output and a ground truth image.

To begin, a training system 502 receives training digital images 504. A downsampling module 506 then employs a script to generate downsampled training digital images 508. The downsampling module 506, for instance, employs a script that down samples the training digital images 504 (e.g., by a factor of ten) thereby improving training efficiency in operation of the loss function 212. The training system 502 then leverages a flattening module 510 to “flatten” the downsampled training digital images 508 to form a vector 512.

The vector 512 is then provided as an input to the machine-learning model 122 for training using a loss function 212. The loss function 212 in the illustrated example combines several terms, each representing different objectives. A background opaque loss term 516 is configured to control opacity of background regions. A foreground transparent loss term 518 is usable to control transparency of objects in a foreground. An input color theme term 520 is usable to control aggressiveness of the machine-learning model 122 in maintaining use of colors from the digital image 116. In an implementation, a multiplier is employed to balance the relative importance of honoring foreground versus generalization. To generate images, the machine-learning model 122 predicts HSBA values of each pixel in the background 124 using the neural network 210.

In the following discussion of the loss function 212, the terms “‘actual” refer to ground truth (mask) or target values and “pred” are the predicted values (HSBA) of the pixels of the background as defined by an output image vector 514.

In a first example, a background opaque loss term is used to control opacity of background regions (block 1014), an example of which is described as follows:

Loss_1=mean((actual²-pred [:−1:]²)*(1-actual))

The term “Pred [:−1:]” is used to isolate alpha values predicted by the machine-learning model 122. The term “(actual²-pred[:−1:]²)” is a squared difference between the mask and the predicted alpha values.

Since the mask has “0” (e.g., black) color in the background regions and “1” (e.g., white) in the foreground regions, the term “(1-actual)” reverses these values. Multiplying the squared difference values with “(1-actual)” is used to focus on background pixels. For the foreground pixels, the squared difference values are multiplied by “0.” Hence with this loss term, the machine-learning model 122 is biased (i.e., “pushed”) to output “0” alpha in the background regions.

In a second example, a foreground transparent loss term 518 is configured to control transparency of foreground regions (block 1016) as follows:

Loss_2=exact_fit_multiplier*mean((actual²-pred [:−1:]²)*actual)

The term “Pred [:−1:]” is used to isolate alpha values predicted by the machine-learning model 122. The terms “(actual²-pred[:−1:]²)” are the squared difference between the mask and the predicted alpha values.

On multiplying the squared difference values with “(actual),” focus is achieved towards foreground pixels. For the background pixels, the squared difference values are multiplied by “0.” Hence with this loss term, the neural network 210 of the machine-learning model 122 is “pushed” to output “1” alpha in the foreground regions. The term “exact_fit_multiplier” is utilized to penalize operation of the machine-learning model 122 further into aggressively honoring foreground objects. This multiplier is directly controllable by a user from the user interface output by the control module 206, e.g., as the honor foreground theme control 406.

In a third example, an input color theme term 520 is configured to cause colors of the predicted values to correspond to a particular color theme (block 1018) as follows:

squared_diff_i=(Pred [: : 3]²-colorTheme[i]²)

squared_diff=min(squared_diff_i)

Loss_3=mean(squared_diff)

In this example, the term “Pred [: :3]” isolates HSB values predicted by the machine-learning model 122. The term “(Pred [: :3]²-colorTheme[i]²)” is a squared difference between the “i^{th}” color theme (e.g., seed color) and predicted HSB values. The machine-learning model 122 is configurable to be biased towards output of colors as consistent with a color theme (e.g., multiple colors) or a single color.

The “minimum squared_diff_I” per pixel is picked by “min(squared_diff_i).” A final loss term is calculable as a mean value of the “final squared_diff” value. Hence this loss function pushes each pixel to have an HSB value closer to one of the colors in the color theme, i.e., a seed primary color.

The loss function 212 is then configurable using these three terms as follows:

Loss=mean (Loss_1, Loss_2, Loss_3)

Once trained, the machine-learning model 122 is configurable to generate the background 124 as described above.

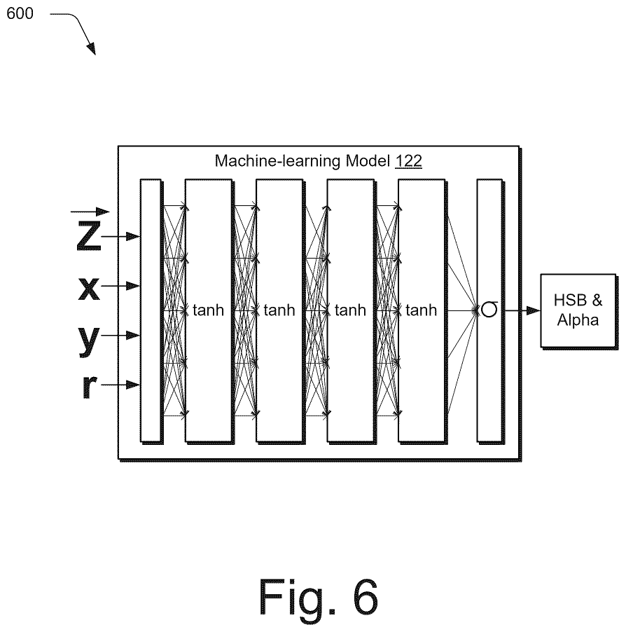

FIG. 6 depicts an example implementation showing an architecture 600 of the machine-learning model 122 of FIG. 5. The machine-learning model 122 uses a neural network 210 with a configurable number of layers and units per layer. An activation function used in each layer is a hyperbolic tangent function “tanh” in the illustrated example. The loss function used for training is a combination of four loss terms in this example: (1) mask loss, (2) color harmony loss, (3) variance loss, and (4) color difference loss. The machine-learning model 122 is trained in one or more examples using a Root Mean Square Propagation “RMSProp” optimizer with a learning rate of 0.01 and a batch size of 4096. The number of epochs is set to twenty, and an initial weight of each neuron is set to a random value.

As previously described, the variance control 404 is used to control an amount of variance employed by the machine-learning model 122. To do so in this example, the variance control 404 supports manipulation of initialization of weights of the machine-learning model 122 by adjusting the variance parameter. To ensure that the model's weights are initialized in a manner that aligns with a desired outcome, for instance, a variance scaling initializer is utilized. By modifying the variance value through the variance control 404, the initialization process and its impact on the background 124 is controlled.

When the variance is set to a low value, for instance, the weights are initialized in such a way that the resulting background 124 exhibits low variance. This initialization strategy promotes the generation of images with smoother gradients and fewer color variations. In this way, user interaction is supported as a customization feature that enhances the flexibility and adaptability of the machine-learning model 122, thereby allowing user control to fine-tune the weight initialization process according to corresponding preferences and requirements.

The color theme for the generated background 124 is controllable by providing a seed primary color, e.g., by specifying a single color or a set of colors. The output image vector 514 is evaluated based on the loss function 212 as defined above. The background 124 is then applied to the digital image 116 (block 1020) and the digital image as having the background for display in a user interface (block 1022). Overall, the machine-learning model 122 takes an input digital image 116 and generates the background 124 as an output image with specific colors and patterns based on a set of configurable parameters.

As a result, the background generation system 120 is configured to support generation of a diverse range of backgrounds, including animations, dynamic backgrounds, radial backgrounds, symmetric backgrounds, metallic backgrounds, patterns (e.g., triangular, rectangular, waves), and so forth. By moving away from conventional techniques to instead address a concept of objects in a foreground of the digital image 116, the background generation system 120 is configured to generate the background 124 with increased visual harmony and visual engagement, elevating an overall quality and impact of the digital image 116 that is not possible in conventional techniques.

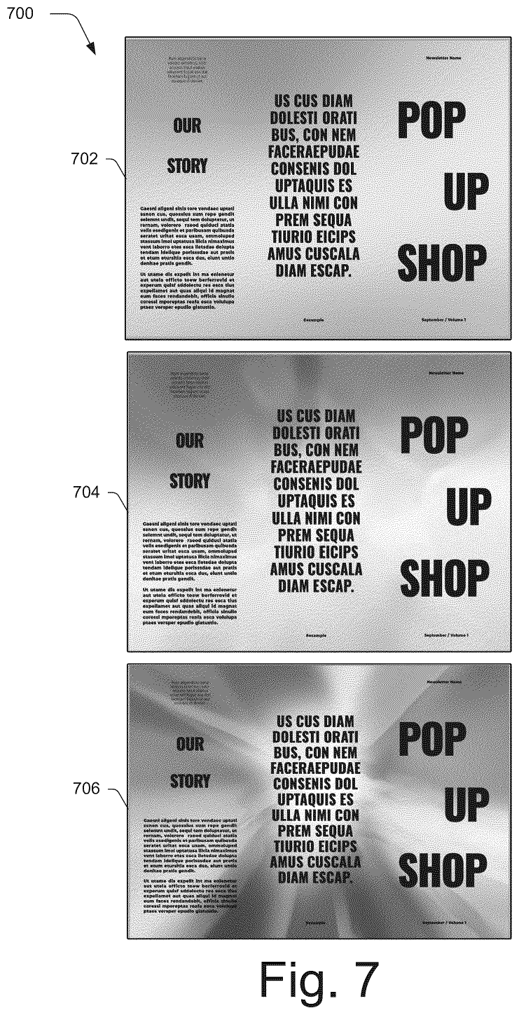

FIG. 7 depicts an example implementation 700 showing different amounts of variance as applied by a machine-learning model 122 of the background generation system 120 as part of background generation. In a first example 702, low variance is applied by the machine-learning model 122, thereby generating a relatively smooth background. A mid-level of variable is applied in a second example 704, which increases color usage and geometric effects that are visible as part of the background. At the third example 706, increased usage of a number of colors is exhibited along with increased definition of geometric features as part of the background.

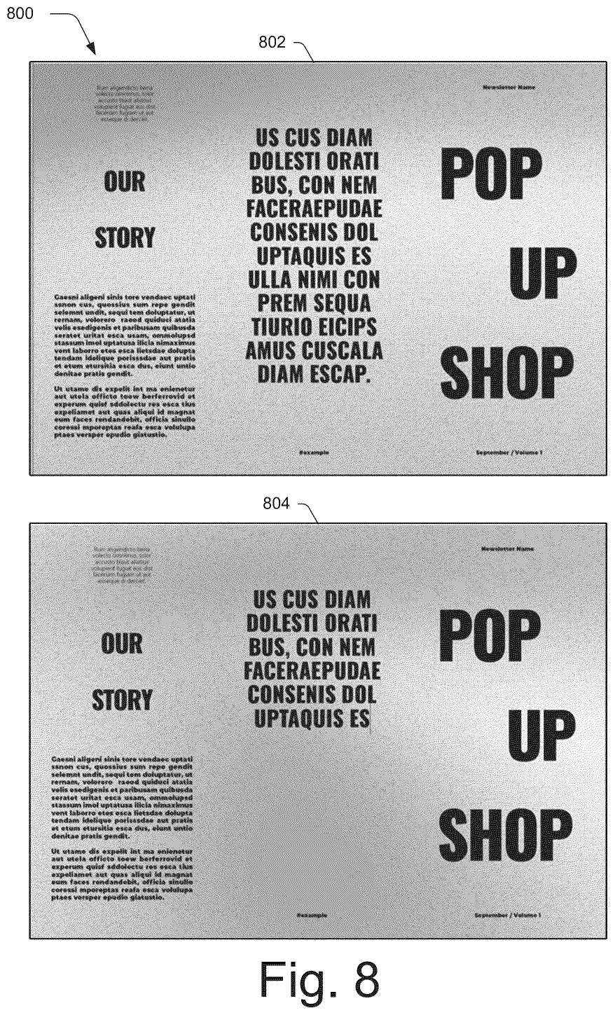

FIG. 8 depicts an example implementation 800 showing dynamic background capabilities as applied by a machine-learning model 122 of the background generation system 120 as part of background generation. The background generation system 120 supports dynamic background capabilities, such that the machine-learning model 122 is adaptable to dynamic changes made to the digital image 116.

Changes, for instance, may be made to a layout, what objects are included in the digital image 116, and so on and in response the background generation system 120 generates a background 124 that incorporates those changes, e.g., dynamically in real time. In the illustrated scenario, in a first example 802 text is disposed across a majority of a central portion of the background, which is reflected in a coloring of the background behind this text. At a second example 804, however, the amount of text is reduced thereby causes a corresponding change in coloration of the background.

This functionality empowers users to modify a content layout, and the background 124 is generated to automatically adjust to these changes based on the foreground of the digital image 116. The machine-learning model 122, for instance, automatically considers the updated mask after a change occurs in the digital image 116 and retrains itself to ensure that the generated background remains accurate and relevant.

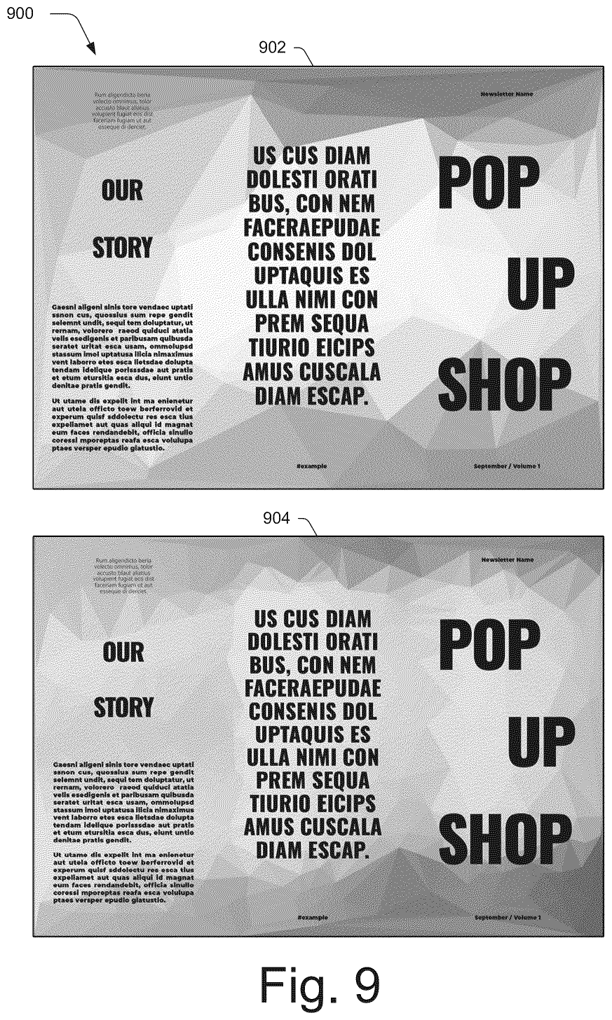

FIG. 9 depicts an example implementation 900 showing pattern background capabilities as applied by a machine-learning model 122 of the background generation system 120 as part of background generation. In the illustrated example, a random triangular grid is generated, e.g., using a Delaunay Triangulation technique. The number of triangles in the grid is user controllable as shown at a first example 902 and a second example 904. Next, an abstract background 124 is generated by the background generation system 120 and then used to “fill in” the triangular grid with color from this generated image. A particular triangle, for instance, is colored based on a corresponding color in the generated background at the triangle's centroid pixel location. Similar techniques are also usable to generate rectangular and wavy patterns as well.

Additional functionalities are also supported by the background generation system 120. As previously described and shown in relation to FIG. 6, for instance, four inputs are provided, which include “r” which denotes the distance from a fixed point on canvas to a symmetric or cyclical function such as “cos(r)” or “sin(r).” Exotic looking backgrounds may also be achieved through use of high variance, e.g., to depict a metallic background.

Animation generation is also supported, e.g., in which the background 124 is one of a plurality of frames of a digital video. To do so, a latent vector “Z” is employed. The generated background 124 is described by a function “f(w,x,y,z,r).” Consider a scenario, therefore, in which, each of the other parameters are fixed and a slight change is made from “Z” to “Z+dz,” where “dz” is a relatively small value. Accordingly, a new image generated as a background 124 by “f(w,x,y,z+dz,r)” is visually similar to an original image used for the background 124, but with slight differences.

Accordingly, the factor “z” may be varied incrementally over small “dz's” from “Z₁” to another value “Z₂.” Corresponding images for each of the small increments are then generated by the background generation system 120 as the background 124. Arranging these images together in sequence for output as a digital video therefore results in generation of an animation that is also context aware. This change of values may be determined automatically or user specified, e.g., in response to movement of a cursor in real time.

The background generation system 120 therefore enhances machine learning technology to generate background 124 that are content and context aware, along with support of user controls. The output can be created at any resolution, independent of an input layout. The background generation system 120 infuses user-controlled colors, foreground emphasis, variance, color themes, and mask information to enable a variety of effects. The generated images of the background 124 further support abstract art-like features that is not possible in conventional techniques. The machine-learning model 122 used by the background generation system 120 is configurable as a randomly initialized neural network, allowing for a versatile architecture that can create different types of images as backgrounds. The background generation system 120 can also employ the use of different types of activation functions to exhibit a variety of results that are not possible in conventional techniques.

### Example System and Device

FIG. 11 illustrates an example system generally at 1100 that includes an example computing device 1102 that is representative of one or more computing systems and/or devices that implement the various techniques described herein. This is illustrated through inclusion of the background generation system 120. The computing device 1102 is configurable, for example, as a server of a service provider, a device associated with a client (e.g., a client device), an on-chip system, and/or any other suitable computing device or computing system.

The example computing device 1102 as illustrated includes a processing device 1104, one or more computer-readable media 1106, and one or more I/O interface 1108 that are communicatively coupled, one to another. Although not shown, the computing device 1102 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1104 is representative of functionality to perform one or more operations using hardware. Accordingly, the processing device 1104 is illustrated as including hardware element 1110 that is configurable as processors, functional blocks, and so forth. This includes implementation in hardware as an application specific integrated circuit or other logic device formed using one or more semiconductors. The hardware elements 1110 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1106 is illustrated as including memory/storage 1112 that stores instructions that are executable to cause the processing device 1104 to perform operations. The computer-readable storage medium is configured for storing instructions that, responsive to execution by the processing device, causes the processing device to perform operations. The memory/storage 1112 represents memory/storage capacity associated with one or more computer-readable media. The memory/storage 1112 includes volatile media (such as random access memory (RAM)) and/or nonvolatile media (such as read only memory (ROM), Flash memory, optical disks, magnetic disks, and so forth). The memory/storage 1112 includes fixed media (e.g., RAM, ROM, a fixed hard drive, and so on) as well as removable media (e.g., Flash memory, a removable hard drive, an optical disc, and so forth). The computer-readable media 1106 is configurable in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1102. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1110. The computing device 1102 is configured to implement particular instructions and/or functions corresponding to the software and/or hardware modules. Accordingly, implementation of a module that is executable by the computing device 1102 as software is achieved at least partially in hardware, e.g., through use of computer-readable storage media and/or hardware elements 1110 of the processing device 1104. The instructions and/or functions are executable/operable by one or more articles of manufacture (for example, one or more computing devices 1102 and/or processing devices 1104) to implement techniques, modules, and examples described herein.

The techniques described herein are supported by various configurations of the computing device 1102 and are not limited to the specific examples of the techniques described herein. This functionality is also implementable all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 abstracts resources and functions to connect the computing device 1102 with other computing devices. The platform 1116 also serves to abstract scaling of resources to provide a corresponding level of scale to encountered demand for the resources 1118 that are implemented via the platform 1116. Accordingly, in an interconnected device embodiment, implementation of functionality described herein is distributable throughout the system 1100. For example, the functionality is implementable in part on the computing device 1102 as well as via the platform 1116 that abstracts the functionality of the cloud 1114.

In implementations, the platform 1116 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
forming, by a processing device, a mask from a digital image;
receiving, by the processing device, an input via a user interface, the input specifying a parameter usable to guide operation of a machine-learning model;
generating, by the processing device, a background by the machine-learning model using generative artificial intelligence (AI) by predicting values for pixels based on the digital image, the parameter, and the mask using a loss function;
applying, by the processing device, the background to the digital image; and
presenting the digital image as having the background for display in a user interface.

2. The method as described in claim 1, wherein the mask specifies a location and a shape of one or more foreground objects in the digital image as well as whether the one or more foreground objects include text or graphics.

3. The method as described in claim 1, wherein the parameter is variance that specifies a relative amount of randomization employed by the machine-learning model in generating the background.

4. The method as described in claim 1, wherein the parameter is a seed primary color.

5. The method as described in claim 1, wherein the parameter is configured to cause the machine-learning model to honor one or more colors included in a foreground of the digital image.

6. The method as described in claim 1, wherein:
the values for the pixels are defined using hue, saturation, brightness, and alpha (HSBA); and
the machine-learning model is configured as a compositional pattern producing neural network (CPPN).

7. The method as described in claim 1, wherein the loss function includes:
a background opaque loss term configured to control opacity of background regions;
a foreground transparent loss term configured to control transparency of foreground regions; or
an input color theme term configured to cause colors of the predicted values to correspond to a particular color theme.

8. The method as described in claim 1, wherein the generating of the background is performed as part of an animation.

9. The method as described in claim 1, wherein the background is abstract and exhibits one or more gradients using three or more colors.

10. One or more computer-readable storage media storing instructions that, responsive to execution by a processing device, causes a processing device to perform operations comprising:
forming a mask from a digital image;
receiving an input via a user interface specifying variance as a relative amount of randomization to be employed in generating a background;
generating the background by a machine-learning model using generative artificial intelligence (AI) by predicting values for pixels based on the digital image, the variance, and the mask using a loss function; and
applying the background to the digital image.

11. The one or more computer-readable storage media as described in claim 10, wherein the loss function includes a background opaque loss term configured to control opacity of background regions.

12. The one or more computer-readable storage media as described in claim 10, wherein the loss function includes a foreground transparent loss term configured to control transparency of foreground regions.

13. The one or more computer-readable storage media as described in claim 10, wherein the loss function includes an input color theme term configured to cause colors of the predicted values to correspond to a particular color theme.

14. The one or more computer-readable storage media as described in claim 10, wherein:
the values for the pixels are defined using hue, saturation, brightness, and alpha (HSBA); and
the machine-learning model is configured as a compositional pattern producing neural network (CPPN).

15. A method comprising:
receiving, by a processing device, training digital images defining respective ground truth images for machine learning; and
training, by the processing device, a neural network using a loss function having a loss term, the training performed to produce a pattern as a background using the training digital images.

16. The method as described in claim 15, wherein the loss term is a background opaque loss term configured to control opacity of background regions.

17. The method as described in claim 15, wherein the loss term is a foreground transparent loss term configured to control transparency of foreground regions.

18. The method as described in claim 15, wherein the loss term is an input color theme term configured to cause colors of the predicted values of the pixels to correspond to a particular color theme.

19. The method as described in claim 15, wherein the pattern is specified using values for pixels that are defined using hue, saturation, brightness, and alpha (HSBA) for three or more colors.

20. The method as described in claim 15, wherein the training includes an additional parameter specifying a relative amount of randomization employed by the machine-learning model in generating the background, a seed primary color, or is configured to cause the compositional pattern producing neural network (CPPN) to honor one or more colors included in a foreground.
